(19) United States
(12) Patent Application Publication
(10) Pub. No.: US 2009/0089057 A1
(43) Pub. Date: Apr. 2, 2009

(54) SPOKEN LANGUAGE GRAMMAR IMPROVEMENT TOOL AND METHOD OF USE

(75) Inventors: Fronz F. BATOT, Austin, TX (US); Randy S. Johnson, Ofallon, MO (US); Tedrick N. Northway, Wood River, IL (US); Howard N. Smallowitz, Austin, TX (US)

Correspondence Address: GREENBLUM & BERNSTEIN, P.L.C., 1950 ROLAND CLARKE PLACE, RESTON, VA, 20191, US

(73) Assignee: INTERNATIONAL BUSINESS MACHINES CORPORATION, Armonk, NY (US)

(21) Appl. No.: 11/865,859

(22) Filed: Oct. 2, 2007

(51) Int. Cl. G10L 15/00

(52) U.S. Cl. 704/251

(57) ABSTRACT

A system and method of improving language skills and, more particularly, a spoken language grammar improvement tool and method of use is provided. The method includes monitoring and analyzing a user's speech pattern; matching a stored undesirable phrase and/or word with the user's speech pattern; and providing feedback to the user when a match is found between the stored undesirable phrase and/or word and the user's speech pattern. A system for monitoring spoken language includes a computer infrastructure being operable to: detect a user's speech pattern; compare the user's speech pattern with stored undesirable words and/or phrases; and provide a notification type to a user that the user's speech pattern matches with at least one of the stored words and/or phrases.

### FIELD OF THE INVENTION

The invention generally relates to a system and method of improving language skills and, more particularly, to a spoken language grammar improvement tool and method of use.

### BACKGROUND OF THE INVENTION

Communication skills include the use of proper grammar, diction and sentence structure when verbally conveying a message to other people. By using proper grammar, diction and sentence structure, for example, a message can be conveyed in an intelligent and more understandable manner. In fact, grammatically correct speech enhances the perceived competence of the speaker and makes for a more effective presentation.

However, it is not uncommon for people to use incorrect grammar. In fact, grammar errors become habitual, as the same errors occur many times, almost becoming involuntary responses. In an attempt to counter this problem, people spend countless hours attempting to correct grammar errors, often without much success. Basically, the current methods of teaching proper grammar are expensive and do not have an overall success rate. Also, these methods are not easy to undertake by the people wishing to correct their grammar.

Currently, to change spoken grammar habits, one needs to bring the action back into the realm of consciousness and regain the ability to make choices which enables the speaker to modify learned (bad) habits. One possible solution is for a person to pay close attention to his or her own speech in an attempt to stop the use of unwanted spoken words or phrases. This is difficult as habits are subconsciously performed and the speaker may not always be aware of the infractions.

Another option is for the person to attend a seminar or workshop in a classroom-type setting. In such an environment, a teacher, for example, a vocal coach, or participants in the classroom/workshop can provide immediate feedback to the student. The drawbacks of such an approach, though, include the cost as well as the time needed to attend these sessions.

Accordingly, there exists a need in the art to overcome the deficiencies and limitations described hereinabove.

### SUMMARY OF THE INVENTION

In a first aspect of the invention, a method comprises monitoring and analyzing a user's speech pattern; matching a stored undesirable phrase and/or word with the user's speech pattern; and providing feedback to the user when a match is found between the stored undesirable phrase and/or word and the user's speech pattern.

In another aspect of the invention, a system for monitoring spoken language is provided. The system comprises a computer infrastructure operable to: detect a user's speech pattern; compare the user's speech pattern with stored undesirable words and/or phrases; and provide a notification type to a user that the user's speech pattern matches with at least one of the stored words and/or phrases.

In still another aspect of the invention, a computer program product comprises a computer usable medium having readable program code embodied in the medium. The computer program product includes at least one component to provide the processes of the invention. More specifically, the computer program product includes at least one component operable to: continually monitor a user's speech pattern which includes words and/or phrases spoken by the user; compare the words and/or phrases spoken by the user with undesirable words and/or phrases stored in a database; and provide feedback to the user when the words and/or phrases spoken by the user match with at least one of the words and/or phrases stored in the database.

### BRIEF DESCRIPTION OF THE DRAWINGS

FIG. 1 shows an illustrative environment for implementing the processes in accordance with the invention;

FIG. 2 shows a configuration of a grammar correction system (GCS) in accordance with the invention; and

FIGS. 3-5 show various flow diagrams implementing processes in accordance with aspects of the invention.

### DETAILED DESCRIPTION OF EMBODIMENTS OF THE INVENTION

The invention generally relates to a system and method of improving language skills and, more particularly, to a spoken language grammar improvement tool and method of use. By implementing the system and method of the invention, it is possible to continually compare a user's speech against stored words and/or phrases. When a match is made between a user's speech pattern and the stored data, an immediate alert or notification is provided to the user for instant feedback of an undesirable speech pattern.

In implementation, a count of matches by word and/or phrase may be stored in a database for historical review and report generation. The report generation may provide many different types of reports useful to the user or others analyzing the user's speech patterns. Optionally, the matches, reports and other generated or stored data can be uploaded to a website and/or other computing device so that other users can provide feedback and support. The website and/or other computing device can also be used as a learning tool by challenging other users to determine whether they can detect and correct a grammar error over a specified period of time.

The advantage of using the tool of the present invention is the immediate identification and notification of a grammatical error or other undesirable speech pattern. Another advantage is the consistent notification to the user, allowing the user to be cognizant of the need to modify their grammar. Advantageously, the benefits can include, amongst others,
(i) Improving grammar;
(ii) Stopping profanity or vulgar speech;
(iii) Reducing filler words (example: uh, um, kind of, okay);
(iv) Stopping or minimizing the use of repetitive phrases;
(v) Minimizing a person's accent;
(vi) Stopping the use of slang terms; and
(vii) Improving communication skills.
   Advantageously, the system and method of the invention takes advantage of various existing technologies such as voice activation tools, voice recognition tools and report generating tools, in a novel manner.

### Illustrative Environments and Configurations of the Invention

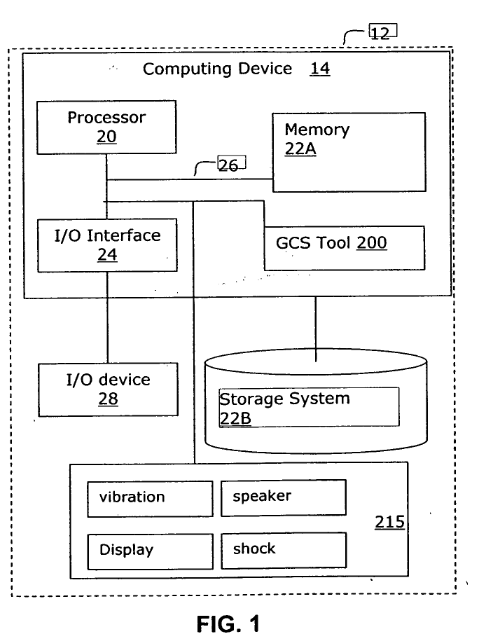

FIG. 1 shows an illustrative computer infrastructure 12 that can perform the processes described herein. In particular, the computer infrastructure 12 includes a computing device 14 that is operable to notify the user of undesirable speech patterns, e.g., words, phrases, grammar, sentence structure, etc. The notification may include many different types of feedback such as, for example, audio, visual or physical. Illustratively, the feedback can include, e.g., a vibration, a visual alert (LED), an audible alert, or a shock.

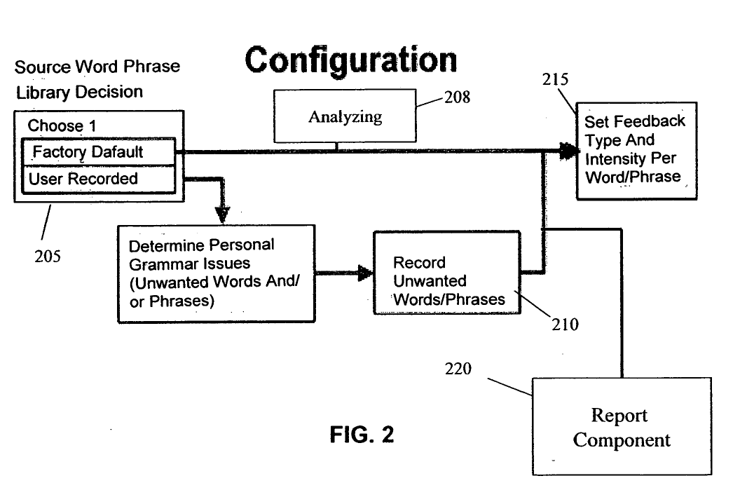

More specifically, the computing device 14 includes a Grammar Correction System (GCS) 200 operable to detect a user's speech pattern. Those of skill in the art should realize that the GCS 200 can be a stand-alone system including the components discussed with reference to FIGS. 1 and 2. Alternatively, the GCS 200 can be a portable device, including only select components such as, for example,
(i) a library of undesirable words and/or phrases;
(ii) a comparison unit (with processor and computer program code) to compare and match the undesirable words and/or phrases with the user's spoken words and/or phrases;
(iii) one or more feedback components to notify the user of any matches of the undesirable words and/or phrases with the words and/or phrases in library; and
(iv) a speech recognition component.
   The components (i) through (iv) can be linked to the remaining components of the computer infrastructure 12 of FIG. 1. The link may be any known wire or wireless link, including but not limited to a USB port connection or any known wireless connection. For purposes of this discussion of FIG. 1, the GCS 200 is shown as a part of the computer infrastructure 12. As such, the computer infrastructure 12 is configured to fully provide the functionality described herein.

The GCS 200 may be activated by voice activation, voice recognition or manually. Also, the GCS 200 is configured to compare and then match the speech pattern, e.g., words and phrases, of a user to that of stored words and/or phrases. The stored words and/or phrases may be factory default settings and/or recorded by the user, as discussed herein. The words and/or phrases can be, for example, any objectionable or undesirable words or phrases such as, but not limited to:
(i) profanity or vulgar speech;
(ii) filler words (example: uh, um, kind of, okay);
(iii) repetitive phrases;
(iv) improper grammar usage; and
(v) slang terms.

The GCS 200 is configured to notify the user of a found match through one or more of the feedback types as shown representatively by feedback component 215. The intensity of the feedback may be factory set or configured by the user, depending on the type of system implementing the GCS 200.

The computing device 14 includes a processor 20, a memory 22A, an input/output (I/O) interface 24, and a bus 26. Further, the computing device 14 is in communication with an external I/O device/resource 28 and a storage system 22B. In embodiments, the storage system 22B stores the factory default settings and the user settings, as well as maintains historical data, report generation data, etc. in accordance with the invention. The I/O device 28 can comprise any device that enables an individual to interact with the computing device 14 or any device that enables the computing device 14 to communicate with one or more other computing devices using any type of communications link. For example, the I/O device 28 can be a microphone, a printer or a display. As should be understood, the microphone can be used to detect the speech pattern of the user or to record the words and/or phrases that the user deems objectionable or undesirable in his/her speech. The printer can be used to print reports and the display can be used to display data, whether it is an analysis of the user's speech, historical information, words and/or phrases entered by the user or factory default settings.

In embodiments, the GCS 200 accesses the memory 22A and storage system 22B to provide the functionality described herein. For example, the GCS 200 accesses the memory 22A to run its computer program code, and accesses the storage system 22B to determine whether any match is recognized with that of the user's speech pattern. The bus 26 provides a communications link between each of the components in the computing device 14.

The processor 20 executes computer program code, which is stored in memory 22A and/or storage system 22B. While executing the computer program code, the processor 20 can read and/or write data to/from memory 22A, storage system 22B, and/or I/O interface 24. The computer program code includes the processes of the invention as discussed herein.

The computing device 14 can comprise any general purpose computing article of manufacture capable of executing computer program code installed thereon (e.g., a personal computer, server, handheld device, etc.). However, it is understood that the computing device 14 is only representative of various possible equivalent-computing devices that may perform the processes described herein. To this extent, in embodiments, the functionality provided by the computing device 14 can be implemented by a computing article of manufacture that includes any combination of general and/or specific purpose hardware and/or computer program code. In each embodiment, the program code and hardware can be created using standard programming and engineering techniques, respectively.

Similarly, the computer infrastructure 12 is only illustrative of various types of computer infrastructures for implementing the invention. For example, in embodiments, the computer infrastructure 12 comprises two or more computing devices (e.g., a Client/Server) that communicate over any type of communications link, such as a network, a shared memory, or the like, to perform the process described herein. The communications link can comprise any combination of wired and/or wireless links; any combination of one or more types of networks (e.g., the Internet, a wide area network, a local area network, a virtual private network, etc.); and/or utilize any combination of transmission techniques and protocols.

A service provider can create, maintain, deploy and support the infrastructure such as that described in FIG. 1. The service provider, such as a Solution Integrator, advertiser, etc., could offer to perform the processes described herein for payment from the customer(s) under a subscription and/or fee agreement and/or the service provider can receive payment from the sale of advertising content to one or more third parties.

FIG. 2 shows an illustrative configuration implementing the GCS 200. The GCS 200 includes a library component 205 composed of factory-installed words and/or phrases, i.e., factory default settings, and/or user-recorded words and/or phrases, i.e., user settings. The user settings allow the GCS 200 to be customizable and can further reduce false positives thereby achieving superior results (matches). The words and/or phrases of the library component 205 can be stored in the storage 22B shown in FIG. 1. The storage 22B (and library component 205) may be maintained, supported and deployed by a service provider.

The factory default settings and/or user settings can be any word or phrase, in any configured language, that is not grammatically correct, or any word and/or phrase which may be objectionable to the user, although not necessarily grammatically incorrect. By way of example, the user can configure the system of the invention to notify the user when the following phrase is used: “It ain't so.”

The GCS 200 also includes a recording component 210. The recording component 210 allows the user to record words and/or phrases based on personal grammar issues. The recording component 210 can also be used to record the user's speech patterns, e.g., recorded words and/or phrases, for future reference and analysis. The user-recorded information may be stored in the library component 205. To record, a user will speak into a microphone.

The GCS 200 further includes an analyzing or matching component 208. The analyzing or matching component 208, analyzes the user's speech and compares the user's speech to the stored data in the library component 205. The comparing of the data may result in a match between the user's speech to the stored data in the library component 205.

The GCS 200 also includes a feedback component 215. The feedback component 215 can include any feedback component such as, for example, a vibration component, an audio component, a display component and/or a shock component. The feedback component 215 is designed to alert or notify the user of a match, e.g., grammatically incorrect or objectionable phrases and/or words, by providing audible, physical and/or visual notification to the user. Illustratively, such feedback type may be an LED, an alarm, vibration or shock, depending on the particular device implementing the GCS 200. In one non-limiting example, a portable digital assistant (PDA) may be configured to vibrate or provide an audible alert.

In addition to alerts (notifications), the feedback may include a recommendation to the user of the proper grammar or word to use in the context of the user's speech pattern. Moreover, in further embodiments, the GCS 200 can notify the user that the diction or enunciation is not clear. Thus, the GCS 200 can also assist the user in identifying failures in pronunciation and diction. This can be provided by the matching processes discussed herein, e.g., if there is no match or a likely match, the GCS 200 may notify the user of an alternative word or recommendation. In still further embodiments, the GCS 200 can monitor the user's speech for unrecognized words or phrases. When this occurs, a user selectable option of alerts is available, and the unrecognized word is captured for further analysis, including historical review. In embodiments, if the unrecognized word or phrase is valid, the user can automatically update the GCS 200 so the word or phrase is recognized in the future.

The feedback component 215 can also be configurable to include a certain intensity level for each feedback type. The intensity level may be set based on, for example, the particular word or phrase used by the user. Illustratively, a high, medium and low setting may be configured based on profane language, idiomatic phrases and frequently used words which are objectionable to the user, respectively. In one embodiment, using the above example, a shock may be used to notify the user when profanity is detected; whereas, a low intensity light may be used to notify the user when the word “um” is detected by the GCS 200.

The GCS 200 further includes a report component 220. The report component 220 is configured to create reports from data stored in a database, e.g., the storage 22B. These reports may be based on the recorded and stored speech patterns of the user, as well as other stored data such as the words and/or phrases most often used by the user, the number and type of alerts provided to the user, etc.

### Processes in Accordance with Implementations of the Invention

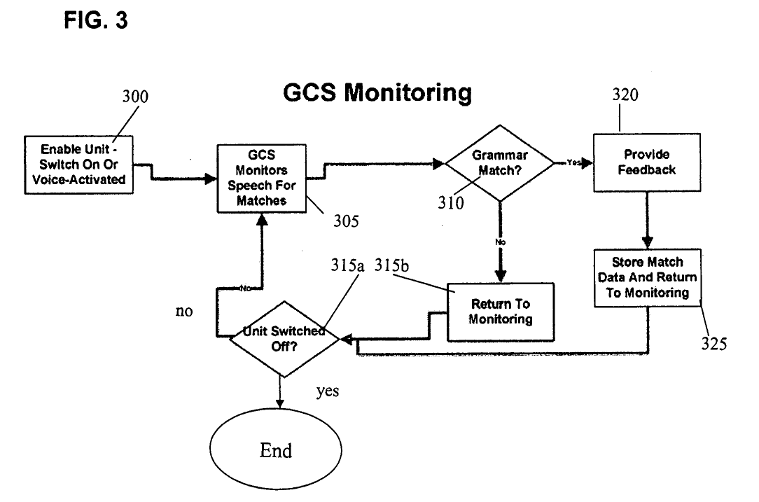

FIG. 3 shows a flow diagram implementing processes in accordance with aspects of the invention. FIG. 3 (and other flow diagrams) equally represents a high-level block diagram of the invention. Additionally, the invention can take the form of an entirely hardware embodiment, an entirely software embodiment or an embodiment containing both hardware and software elements. A software embodiment includes but is not limited to firmware, resident software, microcode, etc. Furthermore, the invention can take the form of a computer program product accessible from a computer-usable or computer-readable medium providing program code for use by or in connection with a computer or any instruction execution system. The software and/or computer program product can be implemented in the environment of FIG. 1. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk—read/write (CD-R/W) and DVD.

Referring to FIG. 3, at step 300, the GCS is enabled (activated) by the user. The user may activate the GCS by, for example, voice activation, voice recognition or manually via a switch. The voice-activated or recognition mode may be used to extend battery life by only monitoring when the GCS detects speech. At step 305, the GCS begins to monitor the user's speech for matches with stored data. These matches may be made by comparing the user's words and/or phrases to the user settings or factory default settings. The speech may be monitored using known speech recognition tools.

At step 310, a determination is made as to whether there is a match between a user's word and/or phrase and the words and/or phrases stored in the database (undesirable words and/or phrases). If there is no match, the process returns to the monitoring at step 315a. However, prior to the monitoring, at step 315b, a determination is made at predetermined intervals as to whether the user is still using the GCS (e.g., whether the user is speaking). If the user is no longer using the GCS, the process ends. If the system determines that the user is still being used by the user, the process will return to step 305.

Returning to step 310, if there is a match between the spoken words and/or phrases of the user and the stored words and/or phrases, the process will continue to step 320. At step 320, the GCS will provide an alert or notification to the user that a match was found. As discussed above, the notification may be visual, audible or physical, with different intensity levels, and/or recommendations for improvement to the user's grammar. At step 325, the match will be stored in the database for future reference, as discussed herein. Historical data can be viewed via a display (LCD interface), or uploaded to a computer or website via a USB interface, for example. The process will return to step 315b.

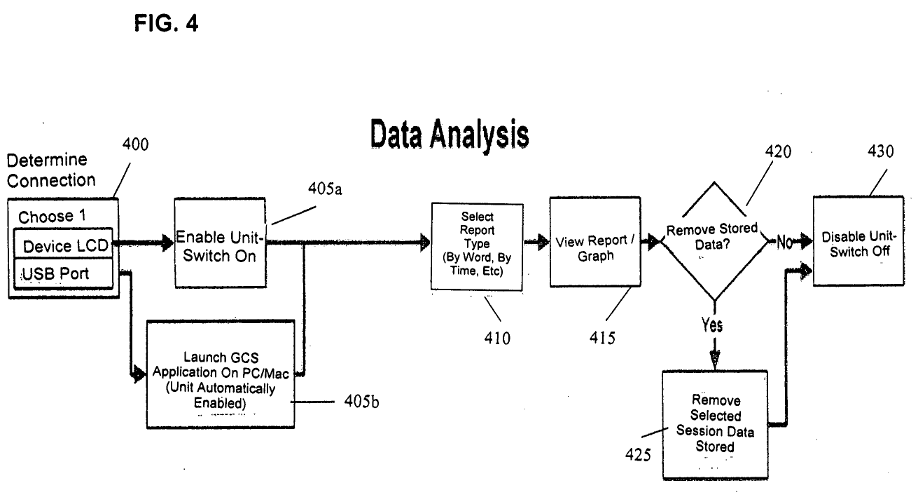

FIG. 4 shows a flow diagram implementing data analysis processes in accordance with aspects of the invention. At step 400, a user selects the connection type. For example, the GCS may be a stand-alone system or the GCS is a portable-type device configured to be connected to a computing infrastructure via a USB port, for example. It should be understood, though, that other connection options are also contemplated by the invention such as, for example, infrared, etc.

In embodiments, at step 405a, if the GCS is a stand-alone component, as represented by FIG. 1, for example, the user activates the system. As a stand-alone tool, the user activates the system by a switch, for example. Alternatively, at step 405b, if the GCS is to be launched on a computing infrastructure such as, for example, a personal computer, the computing infrastructure can automatically be enabled by the detection of a connection to the GCS.

At step 410, a user selects a report type. The report type may be generated from data stored in the storage 22B. Representatively, this data may include the recorded speech patterns, the notification events, the matches found between the user's speech pattern and the factory or user configurable settings, etc. The report type may be, for example, a report outlining, amongst other information:
(i) a number of times certain undesirable words and/or phrases were used by the user;
(ii) a listing of the matched words and/or phrases;
(iii) a comparison of the suggested corrections with the undesirable words and/or phrases; and/or
(iv) the types of notifications and/or intensity of notifications provided to the users.

At step 415, the user may view the report. The report may be transmitted to a display or may be printed, via a wireless transmission, for example. Alternatively, instead of generating a report, the data may be uploaded to a computer device or a website for future retrieval or viewing by the user or other users. The website and/or other computing device can also be used as a learning tool so that the user can monitor and trend their grammar errors over time. In addition, the website and/or other computing device can be used as a learning tool by others. In this embodiment, the other users can be challenged by seeing whether they can detect and correct a grammar error over a specified period of time. The service provider may generate the reports, as well as maintain, support and deploy the website.

At step 420, a determination is made as to whether the stored data should be removed from the storage 22B or other database (including on the website). As discussed above, the stored data (and website) may be maintained, supported and/or deployed by a service provider. If the data is to be removed, then at step 425, the requested data will be removed and the GCS is turned off or the connection between the GCS and the computing device is terminated thereby disabling the computing device. If the data is not to be removed, the process will then proceed directly to step 430.

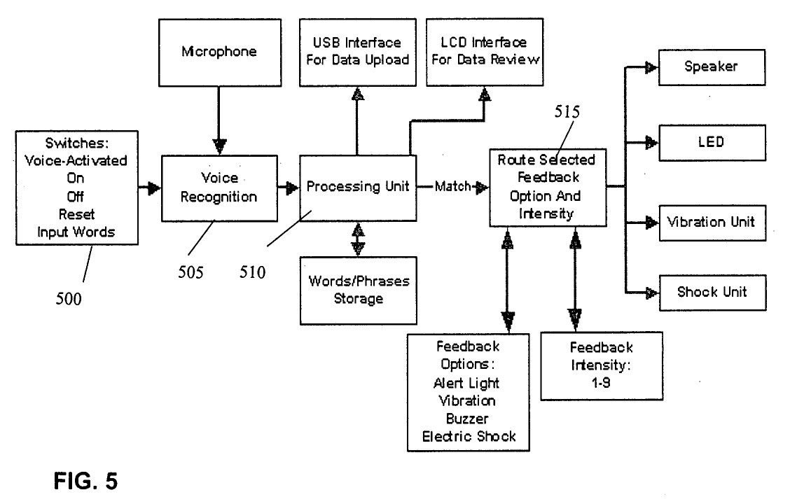

FIG. 5 shows an implementation of the GCS in accordance with the invention. At step 500, the GCS is activated by voice recognition, voice activation, or manually. At step 505, the GCS recognizes the user's voice, using known voice recognition tools. The user, for example, may speak into a microphone, to begin the process, at which time the GCS will recognize the user's voice. At step 510, depending on the mode, the GCS will begin processing the data. For example, depending on the mode, the user may:
(i) record or store user configurable settings for future matching;
(ii) begin speaking at which time the GCS will begin the comparison and matching process;
(iii) connect to another computing device via a USB interface, etc. for data uploading to the computing device or a website; and/or
(iv) review data, whether by a generated report, a website or on user or another computing device.

At step 515, by implementing option (i) of step 510, the user will provide feedback options and respective intensity data to the GCS. In embodiments, the feedback intensity may be based on different scales such as, for example, high, medium or low, or a numerical scale as shown in FIG. 5. Alternatively, implementing option (ii) or (iii) of step 510, the GCS will determine whether there are any matches between the user's speech and the factory or user settings. If a match is found, then the feedback type and intensity will be triggered, notifying the user of an undesirable speech pattern. The feedback type may be provided by a speaker, LED, vibration component or shock component, all of which can be implemented by those of skill in the art without undue experimentation. Also, as discussed above, the feedback may be a recommendation to the user of the correct grammar, word or improved diction or pronunciation.

While the invention has been described in terms of embodiments, those skilled in the art will recognize that the invention can be practiced with modifications and in the spirit and scope of the appended claims.

What is claimed is:

1. A method, comprising:
monitoring and analyzing a user's speech pattern;
matching a stored undesirable phrase and/or word with the user's speech pattern; and
providing feedback to the user when a match is found between the stored undesirable phrase and/or word and the user's speech pattern.

2. The method of claim 1, wherein the feedback is at least one of a visual notification, an audio notification and a physical notification.

3. The method of claim 1, wherein the feedback is a recommendation of an alternative word and/or phrase.

4. The method of claim 1, further comprising generating a report comprising at least one: a number of times certain undesirable words and/or phrases were detected; a listing of the matched words and/or phrases; a comparison of suggested corrections with the undesirable words and/or phrases; and types of notifications and/or intensity of notifications provided to a user.

5. The method of claim 1, further comprising providing factory set words and/or phrases for matching with the user's speech pattern.

6. The method of claim 1, further comprising continually monitoring the user's speech pattern and notifying the user when the match is found between the stored undesirable phrase and/or word and the user's speech pattern.

7. The method of claim 1, further comprising automatically activating the monitoring by voice activation or voice recognition and switching off the monitoring when it is determined that the user is no longer speaking for a predetermined amount of time.

8. The method of claim 1, further comprising storing the user's speech pattern.

9. The method of claim 8, further comprising generating a report based on the stored user's speech pattern.

10. The method of claim 1, further comprising uploading the user's speech pattern and the match with the stored undesirable phrase and/or word to a website.

11. The method of claim 1, further comprising providing a computer infrastructure implementing the steps of claim 1, the computer infrastructure being at least one of created, deployed, maintained and supported by a service provider.

12. A system for monitoring spoken language, comprising:
a computer infrastructure being operable to:
detect a user's speech pattern;
compare the user's speech pattern with stored undesirable words and/or phrases; and
provide a notification type to a user that the user's speech pattern matches with at least one of the stored words and/or phrases.

13. The system of claim 12, wherein the computer infrastructure is configurable to record user suggested words and/or phrases.

14. The system of claim 12, wherein the notification type is at least one of a visual, audio and physical notification.

15. The system of claim 12, wherein the computer infrastructure is operable to generate reports based on the user's speech pattern with the stored undesirable words and/or phrases.

16. The system of claim 12, wherein the computer infrastructure is operable to connect with another computer infrastructure to upload data associated with at least one of the user's speech pattern, the stored undesirable words and/or phrases and the notification type.

17. The system of claim 12, wherein the computer infrastructure is operable to provide a certain intensity level for the notification type.

18. The system of claim 12, wherein the computer infrastructure is created, maintained, deployed and supported by a service provider.

19. The system of claim 12, wherein the computer infrastructure is provided to an end user on a fee or subscription basis.

20. A computer program product comprising a computer usable medium having readable program code embodied in the medium, the computer program product includes at least one component operable to:
continually monitor a user's speech pattern which includes words and/or phrases spoken by the user;
compare the words and/or phrases spoken by the user with undesirable words and/or phrases stored in a database; and
provide feedback to the user when the words and/or phrases spoken by the user match with at least one of the words and/or phrases stored in the database.
